(19) United States
(12) Patent Application Publication
(10) Pub. No.: US 2005/0102414 A1
(43) Pub. Date: May 12, 2005

(54) Systems and methods to support quality of service in communications networks

(75) Inventors: Susan Hares, Saline, MI (US); John Tavs, Palo Alto, CA (US)

Correspondence Address: PERKINS COIE LLP, P.O. BOX 2168, MENLO PARK, CA, 94026, US

(73) Assignee: SHAILESH MEHRA

(21) Appl. No.: 10/944,398

(22) Filed: Sep. 16, 2004

Related U.S. Application Data
(60) Provisional application No. 60/503,760, filed on Sep. 16, 2003.

(51) Int. Cl. G06F 15/16

(52) U.S. Cl. 709/232

(57) ABSTRACT

Systems and methods are described for supporting Quality of Service assurances for communication by and between software applications over a best-efforts networks. Characteristic signatures are generated and referenced to segregate traffic on the network into discrete flows. Traffic engineering protocols, such as MPLS, are used to generate discrete paths in the best-efforts network, and flows are routed on such paths based on pre-set policies. The state of individual paths and the network at large are continuously monitored in order to re-map flows on paths and maintain the QoS assurances.

### CLAIM OF PRIORITY

This application claims priority to U.S. Provisional Application No. 60/503,760, entitled APPLICATION-LEVEL QOS FOR AN MPLS NETWORK, inventors Susan Hares, John Tavs, filed Sep. 16, 2003, which is hereby incorporated by reference in its entirety

### FIELD OF THE INVENTION

The invention relates to the field of networking technologies. More specifically, the invention relates to the provision of Quality of Service for information communicated via a network.

### BACKGROUND OF THE INVENTION

Historically, the Internet is a best-efforts network that treats all network traffic in an equivalent fashion. If a congestion point develops in the network, devices in the network will drop packets, and rely on a protocol such as TCP to retransmit these packets at a latter time. While this approach can work in many cases, it has multiple fundamental limitations, which include:
The fact that retransmissions might be ineffective and potentially damaging to the network as multiple parts attempt to access limited resources.
Rouge applications that can steal bandwidth away from well-behaving applications.
Undesirable effects on particular types of applications, such as voice and video applications, which are often are more sensitive to delay, and which operate more effectively if packets are dropped more aggressively rather than retransmitted.
Undesirable effects on other types of applications, such as file transfers, which are very sensitive to packet drops, but are amenable to retransmissions.
Undesirable effects on certain business critical applications, which use relatively little bandwidth, but which demand predicable response times and infrequent packet-drops.

As a result of these limitations, applications regularly break on best-efforts networks using protocols such as TCP/IP networks, and the prior art includes attempts to improve Quality of Service for particular applications.

A common response to these issues is to over-provision bandwidth and thereby attempt to pre-empt Quality of Service problems. While this approach has merit, it can be prohibitively expensive, and does not solve the rouge application problem that is becoming increasing problematic. Furthermore, this solution will face obvious scaling issues as traffic flow on the Internet continues to multiply.

Another technique used to address these issues exploits existing router queuing and stateless classification capabilities to improve Quality of Service, or QoS, for protocols such as IP. While this technique worked reasonably well for enterprises, particularly for older and simpler applications/protocols such as telnet, NFS, X-Windows and HTTP, routers do not have the memory or CPU capacity to classify more advanced protocols, and have very limited abilities to deal with rouge traffic. Queuing network traffic is also an unfeasible approach to QoS, in part because there has not been a viable model for a service provider to offer such mechanisms to enterprises; in particular, queuing techniques have not been a viable alternative to provide committed bandwidths levels, error rates, and response times to enterprises.

Protocols such as Multi Protocol Label Switching, or MPLS, have emerged from attempts to add the traffic engineering capabilities to the Internet. However, MPLS currently has no provision for applications awareness, and accordingly, the current state of MPLS technologies are inadequate to address the problems of applications QoS described above. These and other limitations of the prior art are addressed by the invention as described herein.

### SUMMARY OF THE INVENTION

The invention includes systems and methods for supporting Quality of Service for software applications that communicate over a best-efforts network such as the Internet. Embodiments of the invention include mechanisms for discovering, identifying, and/or classifying network traffic corresponding to software applications, or “flows”, and determining polices, or rules to be implemented on such traffic in order to support Quality of Service metrics for the respective software applications. Embodiments of the invention include techniques to classify network traffic related to software applications into flows by use of signatures for such flows. These signatures may detect certain fields in header packets, may detect certain types of traffic characteristics, or may identify particular strings in packet payloads.

In embodiments of the invention, the rules may specify label-switched paths on which flows are to be routed. In some embodiments, the rules select the label-switched paths based on desired traffic characteristics for the applicable software applications. In some embodiments, the label-switched paths are also selected based on current states of the Internet as whole or of the respective label-switched paths in particular. In certain embodiments, the label-switched paths are established by use of a label switching protocol, such as MPLS. Other embodiments of the invention utilize alternative traffic engineering mechanisms for routing application-related flows. In some embodiments, flows are routed over IP traffic pipes, in response to policies encoded to support QoS guarantees for those flows.

Embodiments of the invention further include systems and methods for continuously monitoring an analyzing the state of a network, as well as particular paths within a network. Some such embodiments allow determinations of whether a network, or particular segments or paths within a network, have become unsuitable for certain types of flows related to software applications. Embodiments also allow the detection of anomalies on such networks or paths, such as attacks or intrusions. Embodiments of the invention apply policies to flows in response to changes to the state of a network or particular paths within the network in order to re-map flows in response. These and other embodiments are described in greater detail herein.

### BRIEF DESCRIPTION OF THE DRAWINGS

FIG. 1 illustrates a process for classifying network traffic, in accordance with embodiments of the invention.

FIG. 2 illustrates the operation of a software engine for classifying microflows traversing a best-efforts network, in accordance with embodiments of the invention.

FIG. 3 illustrates a process for matching signatures identifying types of traffic on a best efforts network, in accordance with embodiments of the invention.

FIG. 4 illustrates prioritization levels amongst policies for filtering network traffic in accordance with embodiments of the invention.

FIG. 5 illustrates a process for decomposing microflows, in accordance with embodiments of the invention.

### DETAILED DESCRIPTION OF THE INVENTION

The invention supports Quality of Service (QoS) for software applications which communicate via a best-efforts network. Embodiments of the invention include one or more of the following aspects:
Classification of network traffic related to software applications
Analysis of the state of a network or particular segments of the network
Enforcement of policies, or rules, governing traffic traversing a network
Reporting a state of a network or of particular traffic traversing the network

These aspects of the invention may be performed on one or more software modules, or ‘engines’, which may be resident on nodes of the applicable networks. Each of these aspects of the invention is elaborated upon further herein.

Classification

Embodiments of the invention involve classifying network traffic by identifying all of the major types of traffic that exist within an area of the network. Embodiments of the invention also allow the tracking of existing and newly emerging applications deployed in networks. As new applications are continually being developed, some of which aggressively hide their identities, embodiments of the invention also enable the classification of new applications, so that traffic related to such new applications can be appropriately classified when encountered in a network.

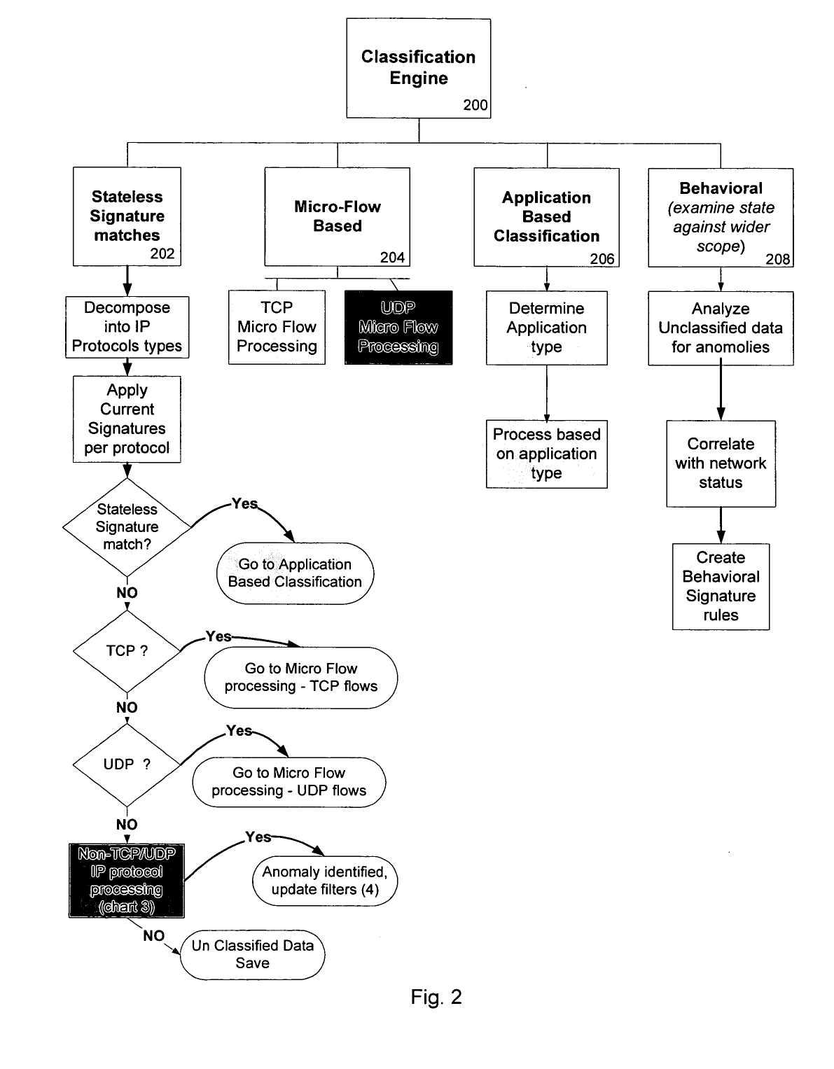

Embodiments of the invention include a classification engine 200, whose operation is illustrated by example in the flowchart of FIG. 2. The classification engine classifies network traffic into discrete flows that may be signature based 202, identity or “flow” based 204, application based 206, and/or behavioral based 208, each of which is elaborated upon further herein. This invention allows identity or flow-based 204 classification to include flows that are identified by a client-server data traffic direction, the connection identifier of the flow, and/or the HTTP information associated with a flow. Other identity-based flows 204 shall be readily apparent to those skilled in the art.

Embodiments of the invention also allow for a classification that is application specific. Nonlimiting examples of such application specific classifications include HTTP, VoIP, VPN, SSL, databases, and other types of application software traffic which shall be readily apparent to those skilled in the art.

Behavior-based flows include traffic that may exhibit certain behaviors on the network. The invention creates new application classifications based on the results of an analysis engine on application or network traffic at all layers. In embodiments of the invention, this classification allows traffic exhibiting certain behaviors to be placed on certain MPLS or Traffic Engineered paths, such as Label Switched Paths, or LSPs.

Signature Analysis

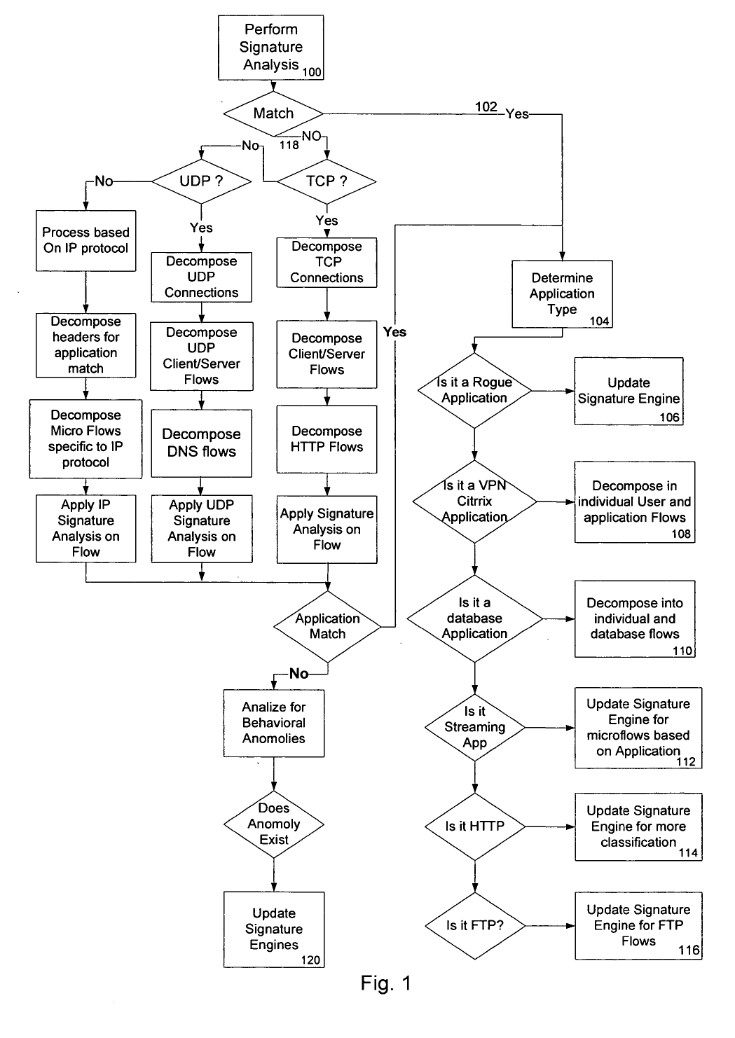

FIG. 1 illustrates a classification process according to embodiments of the invention. The process proceeds by performing an analysis of packet signatures 100, as further described below. If the sampled traffic matches a recognized signature 102, the traffic is mapped to an application type 104 and associated with an appropriate flow 106 116. If the application does not map to a recognized signature 118, the flow is further analyzed and a signature database is updated 120.

Signature analysis includes the process of looking within a single packet to match a particular byte pattern in the packet. Embodiments of the invention use a two phased (two phase) approach to detect signatures. One phase involves a direct scan of bytes in a data stream. The second phase comprises multiple stages of filters set by configurations, as elaborated upon below. Use of this two phased (two phase) approach reduces the aggregate time commitments for filtering.

Scanning techniques used for the direct-scan phase in embodiments of this invention in this invention identify a particular set of bytes in the data stream. In some embodiments, the scanning technique may utilize hardware enhanced techniques for scanning bytes (via serial or parallel processing) to match strings; other implementations of signature analysis shall be apparent to those skilled in the art. In some embodiments, software scanning techniques may be used to directly scan bytes in a data stream. Some embodiments may use a compiled signature analysis technique, such as Aho-Corasick or Wu-Manber, or other such alternatives which shall be apparent to those skilled in the art.

In embodiments of the invention, the second phase uses multiple stages of filtering to analyze the data for particular data signatures, thereby reducing the time commitments for the processing of each filter. Embodiments of this invention allow for multiple layers of filters, or policies, including high level, low level, and micro level filters/polices. In some such embodiments, these filters may be stored hierarchically, as further provided in U.S. provisional application 60/567,192, entitled “Remote Management of Communication Devices,” inventors Wenjing Chu, Bison Tao, Allan Rubens, Andrew Adams, James (Qiuming) Li, and Susan Hares, filed Apr. 20, 2004, which is hereby incorporated by reference in its entirety. The present invention allows layers of policies to be encoded and stored hierarchically.

Grouping of Signatures

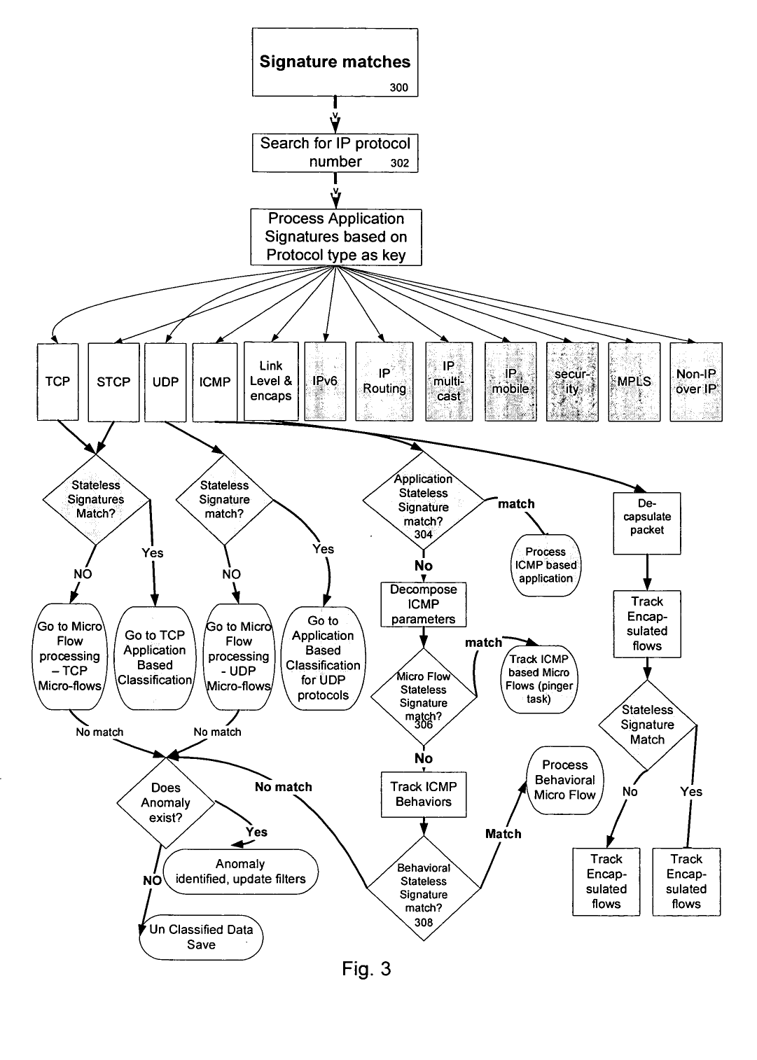

As illustrated in FIG. 3, embodiments of the invention allow signatures to be grouped by:
IP protocol number/type 302, and
Within an IP protocol, by application signature 304, by micro flow signature 306, and by behavior signatures 308.

This grouping of signatures allows for the use of a shorter search pattern for each signature, thereby lessening the computational load of the sequential filters.

Grouping of Signatures by Administrators/Users

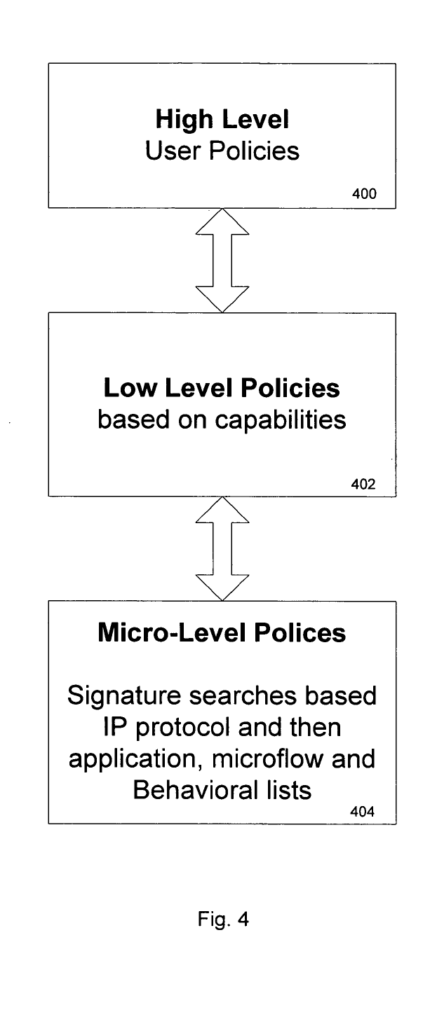

Embodiments of the invention include a user-level interface that presents the choices in high level terms for classification, analysis, enforcement and reporting. The user-level interface may prioritize types of applications, as illustrated in FIG. 4. By way of illustrative, non-limiting example, database and VPN applications may be assigned highest priority for delivery 400. Lower priority applications may be e-mail applications, HTTP applications, and instant messaging applications 402. Peer-to-peer applications, by way of non-limiting example, may be restricted from network resources 404.

Analysis of Microflows

Embodiments of the invention include the analysis of micro-flows. A micro-flow includes a distinct unit of applications related-traffic that traverses, a network, such as an IP network, and contains one or more IP packets. In embodiments of the invention, individual microflows can be aggregated into larger microflows, if a logical relationship exists between the flows. By way of illustrative, non-limiting example, access to a specific SQL database can be included in a microflow; as another example, a series of SQL requests can be aggregated into a microflow. A microflow may be identified by a tuple with elements including one or more of a protocol type, source address, destination address, source port, destination port. Other alternative examples or characterizations of microflows shall be apparent to those skilled in the art.

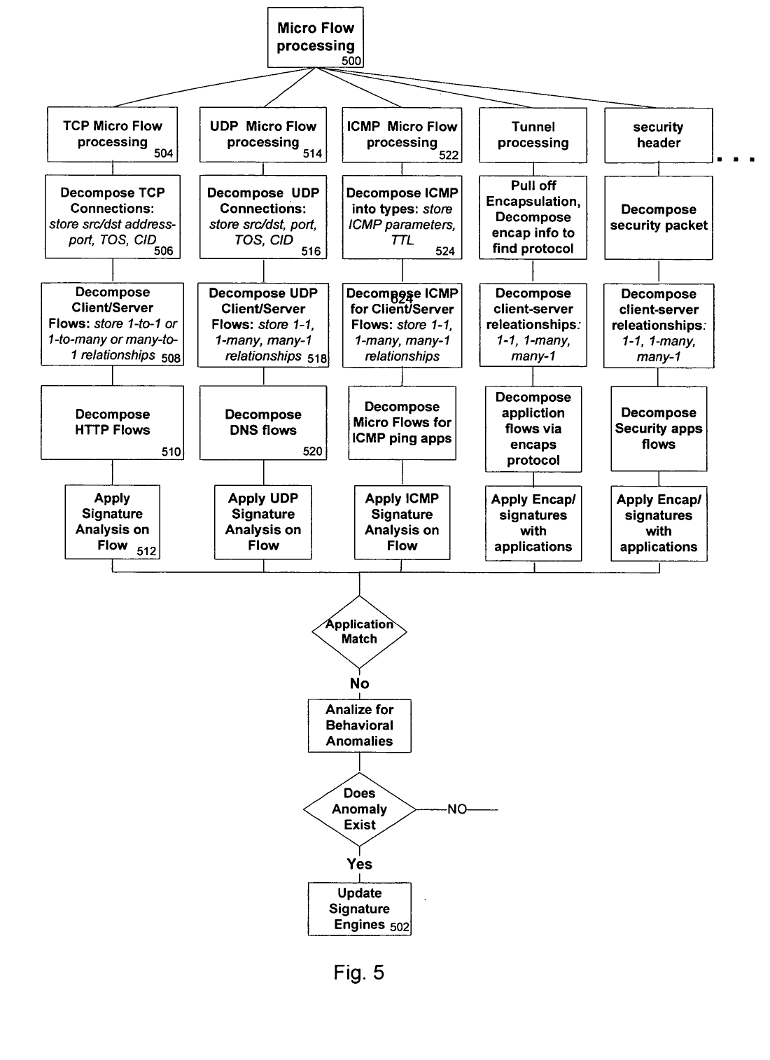

By way of illustrative, non-limiting example, FIG. 5 illustrates a method by which microflows may be deleted and signatures for micro-flows 502 may be generated and added to a database. For TCP-based microflows 504, after the initial stateless signatures have been checked, the TCP headers and application headers are retrieved 506 to detect flow signatures. The classification process decomposes TCP flows 506, client-server flows within TCP flows 508, and HTTP flows 510 within TCP flows and client-server flows to form a basis for matching an application signature 512.

For UDP-based microflows 514, after the initial stateless signatures have been checked the classification process decomposes the UDP headers 516, client-server flows within UDP flows 518, and UDP based applications (DNS, SNMP).

For ICMP based microflows 522, to detect misuse of the network bandwidth based on attacks (non-limiting examples of which include SMURF attacks and ICMP blasting), ICMP packets are decomposed based on the ICMP parameters 524. The ICMP packet is then decoded and micro-flows of the ICMP information are tracked.

Example of Classification by Behaviors: Security Attacks

Embodiments of the invention enable the classification of security attacks. Non-limiting examples of such attacks include Dictionary attacks, SMURF attacks, Ping sweeps, TCP scans, UDP scans, and SYN floods, and other types of attacks that are well-known in the art. As an example of one such attack, a ping sweep occurs where a “smurf” site sends “pings”, via the ICMP protocol, to all nodes within a network. In embodiments of the invention, a classification engine will save statistics on the ICMP protocol by message types on a network by two categories: all addresses and a single address. In some such embodiments, the classification engine will detect that a single site has exceeded a threshold of pings, and re-classify ICMP ping traffic from that site.

In embodiments of the invention, patterns of application data may be detected from multiple nodes or from a single node, thereby enabling the detection of Dictionary or application attacks. For example, if a ping sweep occurs where a “smurf” site sends pings to all nodes within a network, the ICMP classification engine will save statistics on the ICMP protocol by ICMP message types on a network and an IP address mechanism. In the example of a ping sweep, a count of pings within a time period is maintained, and if this count exceeds a threshold (e.g., 1000 pings), this would then pre-empt links to a “smurf” site by Label Switched Paths, or LSPs, configured in accordance with the invention. By use of such embodiments, TCP Scans, UDP scans, SYN Floods can be found for a single site or for any groupings of addresses. Maintaining application statistics for patterns of data at individual network devices or multiple network devices configured in accordance with the invention enables such devices to detect the myriad types of distributed network attacks.

Signature Creation

Embodiments of the invention include static and dynamic techniques for creating signatures. In embodiments, static offline mechanisms may include:
Obtaining information about the protocol formats of an application,
Obtaining information about well-known sites, addresses or ports that an application uses,
Obtaining information about the dynamic natures (such in ftp connection) of the mechanism.

Sources of static information can include business research or publicly available information. As a non-limiting example, public sources of behavior-based signatures include the “SNORT” users group and the CERT advisories. Other suitable sources shall be known to those skilled in the art. Dynamic mechanisms may involve running known traffic within a network and recording common techniques. Dynamic statistical mechanisms predict signatures based on partial matches for known patterns.

Analysis of Traffic and Signatures

Embodiments of the invention include an analysis engine which may perform one or more of the following functions:
evaluate unclassified data to create behavioral based classification rules
determine the state of the network for the application of policies/rules
structure, filter, and organize the data for the reporting engine.

An analysis engine utilized by embodiments of this invention includes an analysis of network and application information. This information may include (but is not limited to): bandwidth utilization, network information, network application information, response time metrics and mediation packet times. Other network information that may be used by the analysis engine shall be readily apparent to those skilled in the art.

In embodiments of the invention, certain statistics maintained for network bandwidth are examined to see if they exceed certain thresholds set for applications, servers, clients, users, network nodes, portions of a network, or a network in its entirety. The use of network bandwidth is also examined to see if it exceeds limits for a group of devices or applications. Network protocol information may be examined for route flaps (for e.g., in OSPF, IS-IS, OR BGP), VRRP select router changes, MPLS signaling changes (LDP or RSVP-TE), ICMP packets (especially ping and redirect) and ARP packets. Network applications such as DHCP, DNS, BOOTp, or TTFP may also be examined against limits for normal or excessive use.

In embodiments, response time measurements for network and applications may be examined. These response time metrics may include:
network delay versus server delay
response times of servers
aggregate delay for packets
normalized delays (with data latency removed)
Round Trip Time of packets (which may be used to determine jitter and delay)
   Evaluation of Unclassified Data for Anomaly Detection

Unclassified data can be recorded and processed offline. The Classification engine can be updated with the analysis of offline data. Embodiments of the invention utilize a user adjustable policy to set a “freshness” date on the offline information. This user policy can allow the “freshness” to react to network events or simply time out. For example, end to end network data may go stale as soon as enterprises or carriers enact major changes to their network.

State of the Network

Embodiments of the invention monitor and rate the state of the network. By way of example, routing protocols such as BGP and OSPF as well as end-to-end network routes may be monitored to determine the state of the network. Additional routing protocol information (for e.g., from VRRP, RIP, LDP, and RSVP-TE) may also be used to obtain the state of the network. Link layer protocols, such as ARP, PPP or tunnel traffic, such as L2TP traffic or GRE traffic may be examined for health and indications for attacks. Network utility programs, such as DNS, DHCP, BootP, may also be used to identify attacks; other examples of other suitable network programs for identifying attacks shall be apparent to those skilled in the art.

Network response times may be monitored via active probes (including, by way of non-limiting example, pings, traceroutes, UDP pings, TCP pings) or passive monitoring (including, by way of non-limiting example, netflow, tap on Ethernet, or SNMP data). Measurements methods for end-to-end traffic may include round-trip time, data, loss, latency, jitter, Hops (layer 3, layer 2), and financial cost. In embodiments of the invention, the current state of the network can be characterized by a metric. As one such non-limiting example, the current state can be characterized as ‘good’, ‘bad’, or ‘attacked’. Attacks may be identified by contrasting statistical data on the past performance of the network to the current state of the network, in order to identify aberrations in network performance which are indicative of attacks or other anomalies which should be re-mediated. Such aberrations may include intrusions, which may be detectable by characteristic signatures. Signature for such intrusions may be obtained from sources such as www.snort.org and CERT releases on security issues; other suitable sources shall be known to those skilled in the art.

Enforcement of Rules/Policies

MPLS, along with its Label Distribution Protocols such as RSVP, LDP, and CR-LDP, enable the creation of label-switched paths (LSPs) which in turn support:
The ability to define a path across a IP network with that has specific bandwidth characteristics.
The ability to create effectively multiple independent paths.

The first capability enables bandwidth sensitive applications to run reliably over the Internet, the second capability enables one to segregate traffic into distinct paths. Embodiments of the invention include policies which map microflows to LSPs, created via MPLS protocols, in response to the state of the microflows, demands of applications, and/or the state of the network. Table 1 illustrates, by way of non-limiting example, desired performance characteristics for certain applications.

TABLE 1

| | Latency | BW | Jitter | Loss | Well Behaved |
|---|---|---|---|---|---|
| Transactional | High | Low | Low | Low | Yes |
| File Transfer | Low | High | Low | High | No |
| File Serving | High | High | High | Medium | No |
| Stream Voice | Low | Low | High | Low | No |
| Stream Video | Low | High | High | Low | No |
| VoIP | High | Low | High | Low | Yes |
| SANs | High | High | High | High | — |
| HTTP | High | Low | Low | Low | No |

These applications may be mapped, by reference to their desired performance characteristics, to the traffic types presented in Table 2.

TABLE 2

| Traffic Type | Latency Req'mt | BW Req'mt | Jitter | Example |
|---|---|---|---|---|
| Transactional | High | Low | Low | Oracle, SAP |
| Bulk Data | Low | High | Low | Directory |
| | | | | Sync |
| Latency Sensitve | High | Low | High | VoIP |
| Streaming | Low | High | High | Video |
| Event-Driven | High | Variable | Low | Applet |
| Rogue | High | Aggressive | High | KaZaa |

High Level Policies/Low Level Policies/Signature Policies

In embodiments of the invention, policies/rules may be distinguished as low level policies or high-level policies. Low level policies provide an internal representation of how to do QoS traffic enforcement. High-level policies provide an abstracted view of policies for administration by network operators. In order to speed up the policy engines, low level policies may be further broken down into “micro policies” operative on signatures and low-level policies that combine these micro-policies.

Embodiments of the invention include an interface for network operators to administer high-level policies. Such interfaces may include one or more of the following features:
Recommended policies to be enforced for particular applications
Avoidance of information overload
   By way of non-limiting example, limit the application display to those taking 90% of the bandwidth
Limiting the set of configuration options for ease of administration, further including, by way of non-limiting example
   Hiding the more advance features to advance screen
   Abstracting the features
Ability to save configurations
Templates for common configurations.

In embodiments of the invention, low-level policies are generated automatically from high-level policies. High-level policy decisions will generate low-level policies. As an illustrative, non-limiting example, a network administrator may set a high-level policy providing that a certain number of users are to be allowed to use a particular application. Suppose that the application requires, for example, 30 kbps of bandwidth per user. Low level policies will determine the aggregate bandwidth available for the application on the basis of the number of users set forth in the high level policy, and will also ensure that new users will not be added if this would cause the aggregate available bandwidth for the application to be exceeded.

Recommend Policies

Embodiments of the invention also include a set of recommend policies per application. A recommend policy is an experience based configuration parameter on how to set policy for a specific application. For example, for a particular application, a per user flow may typically consume 30 kbps, which Would be reflected in a recommend policy of 30 kps per user flow. As another, non-limiting example, a peer to peer file sharing protocol may have a trigger a recommended policy which blocks such applications. Embodiments of the invention also allow network operators to override recommended policies.

Policy Templates

Embodiments of the invention include policy templates which are operative when the network is in different operation modes, such as during fare wars between airlines, military conflicts, and data center backups. In these situations the network policy will be dramatically different than in the normative case. Policy templates may be triggered manually or automatically in response to specific events.

Examples of Policy Designs

Traffic Segregation

Based on the number of LSPs created between MPLS endpoints, embodiments of the invention prompt the administrator on recommended policy for segregation of traffic between MPLS endpoints. Table 3 presents, by way of non-limiting example, an illustration of traffic types mapped to distinct, segregated LSPs.

TABLE 3

| LSPs | 1 | 2 | 3 | 4 |
|---|---|---|---|---|
| 2 | VoIP | Multicast/Sans/data | | |
| 3 | VoIP | Multicast/SANs | Data | |
| 4 | SANs | VoIP | Multicast | Data |

Embodiments of the invention further allow network operators to override such mappings.

Traffic Enforcement Policy per LSP

Policy issues involved in traffic assignment to an LSP include how to assign flows to specific LSPs and how to respond if demands exceed a specific LSPs capacity. The initial assignment of flows to LSPs include the following cases.
Manual Configuration—In this case the administrator manually assigns individual flows to individual LSPs.
Repetitive Manual Configurations—A special case of the manual case occurs when a specific flow is frequently mapped to an individual LSP.
Fixed Bandwidth Applications—A special case of the repetitive manual case which occurs when the application has a clear bandwidth requirement per flow. This allows one to state the number of flows (which in practice normally maps to users) one wants to support, freeing the administrator from monitoring whether the bandwidth amount is adequate or inadequate for that application.

Responses to over-subscribed LSPs include the following.
Block further traffic from the flow on the LSP,
Allow a application, but reduce the bandwidth allocated to each of the over-provisioned applications by an equivalent amount,
Remove applications that are less critical from an LSP, or
Queue applications on the LSP.

Another issue addressed by the invention is how to re-allocate assigned bandwidth if the network, or paths within a network, transition from “good” to “bad”. The failure of a circuit can be detected by link failure or node failure. These hard failures can be quickly re-routed in MPLS (for example, with protected circuit groups and fast re-routes). Alternatively, an MPLS circuit may not have a hard failure, but its performance characteristics may become unsuitable for particular applications, i.e., the circuit may only be “bad” for particular software applications. Embodiments of the invention include end-to-end instrumentation at the MPLS layer, network layer, and application layer which continually measure the “goodness” factor to determine when a circuit goes from “good” to “bad”. Once the circuit goes from good to bad and another circuit exists, the MPLS layer can re-map the circuit. If there is plenty of bandwidth, the re-mapping is a matter of switching the pathways and monitoring tools. If there is insufficient bandwidth for applications, the user policy determines an ordering of traffic that goes through. In some such embodiments, the user policies encode Service Level Agreements, and prioritize accordingly amongst application traffic. By way of non-limiting example, the polices may prioritize amongst applications for Storage Area Networks, VoIP, Multicast and Data portions of the affected circuits. Embodiments of the invention provide recommendations for which applications are denied traffic resources if the bandwidth becomes insufficient, and further allow the network operators to override such policies.

Traffic Enforcement Policies per IP Traffic Pipe

Embodiments of the invention employ IP traffic engineered paths, or “traffic pipes”, to provide QoS for application-related traffic on networks. The initial assignment of flows to IP Traffic pipes involve cases analogous to those for LSPs:
Manual Configuration.—In this case administrator manually assigns individual flows to individual IP Traffic Pipes.
Repetitive Manual Configurations—A special case of the manual case occurs when a specific flow is frequently mapped to an individual IP Traffic Pipe.
Fixed Bandwidth Applications—A special case of the repetitive manual case occurs when the application has a clear bandwidth requirement per flow. This allows one to state the number of flows (which in practice normally maps to users) one wants to support on the IP Traffic Pipe, freeing the administrator from monitoring whether the bandwidth amount is adequate or inadequate for that application.

In analogy to the MPLS LSPs, responses to over-subscribed IP traffic pipes include the following:
Blocking further traffic from entering the IP Traffic Pipe
Allowing the assigned application but reducing the bandwidth allocations for all other applications by an equivalent amount
Remove applications that are less critical from an IP Traffic Pipe
Queue application data to be delivered at a later time or when another traffic pipe can be created to handle the traffic overload.

Another issue is how to re-allocate IP Traffic Pipes if the network goes from good to “bad” or fails. The failure of a circuit can be detected by link failure or node failure that will be relayed to the IP routing and forwarding engines. Hard failures can utilize network routing or re-assignment of GRE or IP-in-IP tunnels.

Particular IP network pathways are also monitored to determine if they have gone “bad” for particular applications. In embodiments of the invention, end-to-end instrumentation at the network layer and application layer continually measures the “goodness” factor to determine when a circuit goes from good to “bad. If a circuit goes from good to bad and another circuit exists, the IP Traffic Pipe creation mechanisms can re-map the circuit. If there is plenty of bandwidth in the network's IP Traffic Pipes, the re-mapping is a matter of switching the pathways and monitoring tools. If there is not enough bandwidth for applications, then, in embodiments of the invention, user policies determine an ordering of traffic that goes through. In some such embodiments, the user policies encode Service Level Agreements, and accordingly priority amongst application traffic.

By way of non-limiting example, the user polices may prioritize amongst applications for Storage Area Networks, VoIP, Multicast and Data portions of the affected circuits. Embodiments of the invention provide recommendations for which applications are denied traffic resources if the bandwidth becomes insufficient, and further allow the network operators to override such policies.

1. A method of communication for a plurality of software applications over a wide-area packet-switched network, wherein the packet-switched network communicates via a best-efforts protocol operating on a first layer of the packet-switched network, and a label switching protocol operating on a second layer of the packet-switched network, the method comprising:
at one or more nodes in the wide-area packet-switched network, classifying packets traversing through the one or more nodes into a plurality of microflows, the classifying packets further including
detecting identifying signatures for the packets,
mapping the signatures to the plurality of microflows;
mapping in real-time the plurality of microflows to a plurality of label-switched paths, the label-switch paths generated by the label switching protocol, mapping the plurality of microflows further including
determining a current status of each of the plurality of label-switched paths,
for each micro-flow from the plurality of micro-flows, determining a rule applicable to the micro-flow, wherein the rule specifies one or more network characteristics for the microflow, and
comparing the rule applicable to the micro-flow to the current status of each of the plurality of label-switched paths to select a label-switched path from the plurality of label-switched paths on which to forward the microflow.

2. The method of claim 1, wherein each of the plurality of microflows includes a distinct unit of network traffic related to one or more of the plurality of software applications.

3. The method of claim 2, wherein, for each of the plurality of micro-flows, the one or more of the plurality of software applications have a service level requirement, the service level requirement defined by one or more of the following: a relative priority of the microflow amongst the plurality of micro-flows, a bandwidth requirement for the microflow, a latency tolerance range for the microflow, a jitter tolerance range for the microflow, and a packet-drop tolerance for the micro-flow.

4. The method of claim 3, wherein for each of the plurality of microflows, the rule applicable to the microflow guarantees the service level requirement for the one or more software applications.

5. The method of claim 1, wherein for each of the plurality of label-switched paths, the current status includes one or more of the following: a percentage of bandwidth currently consumed in the label-switched path, an indication of whether the label-switched path is currently live or non-responsive.

6. The method of claim 1, wherein the one or more network characteristics specified by the includes one or more of the following: a relative priority of the microflow amongst the plurality of micro-flows, a bandwidth requirement for the microflow, a latency tolerance range for the microflow, a jitter tolerance range for the microflow, and a packet-drop tolerance for the micro-flow, a port number for the microflow, a protocol-type for the microflow.

7. The method of claim 1, wherein the plurality of software applications includes database applications, virtual private network applications, multimedia streaming applications, e-mail applications, web applications, internet telephony applications, storage area networking applications, file transfer applications, peer-to-peer networking applications.

8. The method of claim 1, wherein the identifying signatures identify headers in the packets.

9. The method of claim 1, wherein the identifying signatures identify payloads in the packets.

10. The method of claim 1, wherein the label switching protocol includes Multiple Protocol Label Switching.

11. The method of claim 10, wherein the label switching protocol includes RSVP.

12. The method of claim 10, wherein the label switching protocol includes LDP.

13. The method of claim 1, wherein the best-efforts protocol includes IP.

14. The method of claim 1, wherein the best-efforts protocol includes TCP.

15. The method of claim 1, wherein the best-efforts protocol includes UDP.

16. The method of claim 1, wherein the classifying packets further includes:
updating one or more state tables for the plurality of microflows.

17. The method of claim 16, wherein the one or more state tables includes a plurality of tuples associated with the plurality of microflows.

18. The method of claim 17, wherein each of the plurality of tuples includes a source address, a destination address, a source port, a destination port, an application from the plurality of software applications.

19. The method of claim 17, wherein the state table further includes a protocol.

20. The method of claim 1, further comprising:
combining two or more microflows from the plurality of micro-flows, wherein the two or more micro-flows are related to a single application from the plurality of software applications.

21. The method of claim 1, further comprising:
combining two or more microflows from the plurality of micro-flows, wherein the two or more micro-flows evidence similar traffic performance, the traffic performance characterized by one or more of a delay, a jitter, and a loss of the two or more microflows.

22. The method of claim 1, further comprising: periodically measuring a status of the packet-switched network in real-time.

23. The method of claim 22, wherein the status of the packet-switch network includes measurements of a current delay, a current jitter, and a current loss on the packet-switched network.

24. The method of claim 22, further including:
re-mapping the plurality of micro-flows to the plurality of label-switched paths in response to one or more events on the packet switched network.

25. The method of claim 24, wherein the one more events on the packet-switched network comprises a surge in network traffic.

26. The method of claim 24, wherein the one or more events includes a security violation on the packet-switched network.

27. The method of claim 26, wherein security violation includes a Denial of Service Attack on the packet-switched network.

28. The method of claim 26, wherein the one or more events includes a SYN Flood on the packet-switched network.

29. The method of claim 24, wherein the one or more events increases jitter on the packet-switched network.

30. The method of claim 24, wherein the one or more events increases delay on the packet-switched network.

31. The method of claim 24, wherein the one or more events increases packet drops on the packet-switched network.

32. A node on a packet-switched network, the packet-switched network in communication via a label-switching protocol, the node comprising:
one or more interfaces coupled to the packet-switched network;
a plurality of label-switched paths coupling the node to one or more destination nodes, wherein node is in communication with the one or more destination nodes via the label-switching protocol over the packet-switched network, wherein the node is operative to monitor a current status network performance of the plurality of label-switched paths in real-time;
one or more tables identifying a plurality of micro-flows traversing the packet-switched network via the node, the one or more micro-flows including network traffic to the one or more destination nodes for a distinct software application from a plurality of software applications, each of the plurality of software applications having a distinct service-level requirement, the distinct service-level requirement including one or more of: a bandwidth requirement and a priority amongst the plurality of software applications;
wherein the node is further operative to re-map the plurality of micro-flows to the plurality of label-switched paths periodically based on the distinct service-level requirement of each of the plurality of software applications and the current network performance of the plurality of label-switched paths.

33. The node of claim 32, wherein the plurality of software applications database applications includes one or more of: virtual private network applications, multimedia streaming applications, e-mail applications, web applications, internet telephony applications, storage area networking applications, file transfer applications, peer-to-peer networking applications.

34. The node of claim 32, wherein the node further comprises:
a database of signatures for network traffic traversing the node, the signatures identifying one or more software applications related to the network traffic.

35. The node of claim 34, wherein the node further comprises:
a database of policies to ensure the distinct service-level requirement of each of the plurality of software applications.

36. The node of claim 34, wherein the node further comprises one or more processes for reading signatures for network traffic traversing the node.

37. The node of claim 36, wherein the node is operative to periodically re-map the network traffic traversing node to the plurality of micro-flows in response to reading signature for the network traffic traversing the node.
